(19) United States
(12) Patent Application Publication
(10) Pub. No.: US 2012/0175226 A1
(43) Pub. Date: Jul. 12, 2012

(54) DEVICE FOR GUIDING A DOUGH WEB

(75) Inventor: Klaus Gasser, Graz (AT)

(73) Assignee: KÖNIG MASCHINEN GESELLSCHAFT M.B.H., Graz-Andritz (AT)

(21) Appl. No.: 13/382,278

(22) PCT Filed: Jul. 5, 2010
(86) PCT No.: PCT/EP2010/059581

§ 371 Date: Mar. 23, 2012

(30) Foreign Application Priority Data
Jul. 7, 2009 (AT) A 1065/2009

(51) Int. Cl. A21C 9/08; B65G 43/00

(52) U.S. Cl. 198/571; 198/570

(57) ABSTRACT

A device for continuously transporting a dough strand, comprising a conveyor element having a support surface for the dough strand displaceable in the direction of transport, wherein the conveyor element is pivotable substantially transversally to the direction of transport about a swivelling axis disposed on the downstream end region thereof.

The invention relates to a device for continuously transporting a dough strand, comprising a conveyor element having a support surface for the dough strand displaceable in the direction of transport.

In EP 0 438 923 B1 there is described a method for continuously compressing a dough mass into a dough band with a uniform cross-section. There is provided upstream of a compression device a feeding conveyor belt with an adjustable transport rate, which feeds the dough mass into the compression device. Downstream thereof there is arranged a discharge conveyor belt for discharging the compressed dough band. At the point, where the dough mass is compressed, the dough width is detected by a dough width measuring device. On the basis of the measurements of the dough width, the rate of the feeding conveyor belt is adjusted in relation to the rate of the discharge conveyor belt. Thus, there is provided a continuous dough band with uniform cross-section and constant rate.

There is, however, not provided in EP 0 438 923 B1 the possibility to adjust the continuous dough band in such a way that this will leave the compression device always in central alignment. For this reason, it may be necessary to carry out cutting of the edges in the case of a dough band that leaves the device not centrally aligned on the discharge conveyor belt in order to prevent that the dough band projects laterally beyond the edge of the discharge conveyor belt. The consequences thereof are at least undesired dough loss and also increased production costs associated therewith. Furthermore, it may be necessary in the case of a rather edge-oriented dough band to interrupt the continuous production in order to re-arrange the dough band in its starting position centrally aligned on the discharge conveyor belt.

In order to overcome these drawbacks, there is proposed in DE 600 20 711 T2 a device for continuously transporting food dough, provided with a dough pushing device, comprising a centering roller, a crank axle and an actuator. This dough pushing device that is arranged at the downstream end of a conveyor device moves the conveyor device with the dough strand arranged thereon on the basis of the signals received by a computing device from width sensors at both edges of the conveyor device, at the downstream end thereof to the left and to the right in relation thereto. The conveyor device is formed in the area of the dough pushing device by numerous individual ropes arranged next to each other, which each run in the grooves of a supporting roller and are commonly driven by this. Depending on the embodiment variant, the supporting roller may be arranged with the grooves upstream or downstream of the centering roller of the dough pushing device. The axes of the centering roller and of the supporting roller are arranged in parallel to each other. The centering roller is driven by an internally situated crank axle in the axial direction in order to push the dough to the right or to the left. The crank axle is provided with an external thread. In a rigid frame that is arranged on both sides of the crank axle and which gives support thereto there is provided respectively an internal thread so that the crank axle with its external thread engages with the internal thread. The crank axle, in turn, is provided with a motorized drive. In this way, the centering roller coupled in terms of movement with the crank axle may be moved back and forth in the axial direction within the frame.

The disadvantage of this embodiment is that the course of the dough strand may be adjusted by the dough pushing device about a central axis only in a rather short band section situated immediately at the downstream end of the conveyor device. In this way, there is not utilized the entire available length of the conveyor device for adjusting the band. Due to the immediate lateral displacement, the dough strand is thus exposed to increased tension and shear stress, respectively, which may have a negative effect on the quality of the dough. Careful adjustment of the dough strand about the central axis thereof, hence, is not possible in this embodiment.

In order to enable a lateral displacement of the dough strand alongside the short section of the downstream end of the conveyor device at all, the conveyor device is formed in this section by numerous flexible individual ropes that are spaced apart from each other in the longitudinal direction instead of the otherwise common conveyor belt that extends in a continuous way across the entire band width. Very soft doughs, however, cannot be transported at all by such a conveyor device formed by individual ropes, which only supports the dough strand in lines, this constituting a further disadvantage of this embodiment.

Thus it is the task of the present invention to provide a device for continuously transporting a dough strand, which prevents the mentioned disadvantages of the state of the art.

This task is solved in a device according to the preamble of claim 1 by the features of the characterizing part of the claim 1. The sub-claims relate to further advantageous embodiments of the invention.

It is especially advantageous that in a device according to the invention for continuously transporting a dough strand, comprising a conveyor element having a support surface for the dough strand displaceable in the direction of transport, the conveyor element is pivotable substantially transversally to the direction of transport about a swivelling axis disposed at the downstream end region thereof. In this way, the transfer section, in which the dough strand is placed onto the support surface of the conveyor element, may be adjusted by swivelling so that the dough strand will rest aligned centrally of the width of the support surface.

As dough strands are designated continuous dough bands as well as individual dough portions that are arranged spaced apart from each other on the conveyor element. Also bands or portions, respectively, of pre-fabricated doughs encompass this designation.

In a device according to the invention the swivelling axis of the conveyor element is usefully arranged centrally of the width thereof. In this way, the swivelling axis lies in the symmetry plane in a central position alongside the conveyor element.

In a preferred embodiment of the invention, the device is characterized in that the swivelling axis is oriented orthogonal to the support surface of the conveyor element. In this way, if required, level differences may be levelled by the conveyor element, and the pivotable conveyor element need not be arranged horizontally.

According to a further feature of the invention, the conveyor element of the invention is configured as a conveyor belt.

Advantageously, there is provided in a device according to the invention for pivoting the conveyor element a swivel drive, which is preferably arranged at the upstream end of the conveyor element. The swivel drive may also be attached at the conveyor element or its frame, respectively, at other positions.

A further useful embodiment of the device according to the invention is characterized in that the upstream end of the conveyor element is pivotable from its central position (16) to both sides by up to 25%, preferably by up to 10% of the width of the dough strand transversal to the direction of transport. Making use of this deflection, deviations of the dough strand, which may be placed on a conveyor belt of a preceding transfer device, for example, transversally or outside of the central position thereof, may be levelled therewith.

In a further embodiment for solving the task according to the invention, a device is characterized in that there is provided a transfer device configured for transferring the dough strand in a section to the support surface of conveyor element as well as comprising preferably a conveyor belt.

Usefully, in a device according to the invention the transfer device is provided upstream of the conveyor element, wherein the conveyor belt feeds in the direction of transport of the conveyor element.

In a variant of the device according to the invention, the transfer device is positioned above the conveyor element, with the conveyor belt feeding in opposition to the direction of transport of the conveyor element.

A device according to the invention advantageously comprises a control unit as well as sensors for detecting the position of both edges of the dough strand, wherein the control unit controls the swivel drive by means of the signals of the sensors so that the dough strand is placed in the transfer section of the conveyor element centrally of its width. Deviations in regard to the position of the dough strand, which may be positioned on the conveyor belt of the transfer device, for example, transversally or outside of the central position thereof, respectively, are thus levelled.

In a device according to the invention the sensors for detecting the position of both edges of the dough strand are usefully arranged at the transfer device. Thus it is possible to early adjust the pivotable conveyor element according to the invention.

In an especially advantageous embodiment, in a device the sensors for detecting the position of the dough edges are photoelectric sensors.

In an embodiment variant of a device according to the invention the sensors for detecting the position of the dough edges are ultrasound sensors. But also other embodiments of sensors for detecting the position of the dough edges are conceivable.

Further features of the invention become obvious from the following description of exemplary embodiments and in consideration of the drawing, wherein:

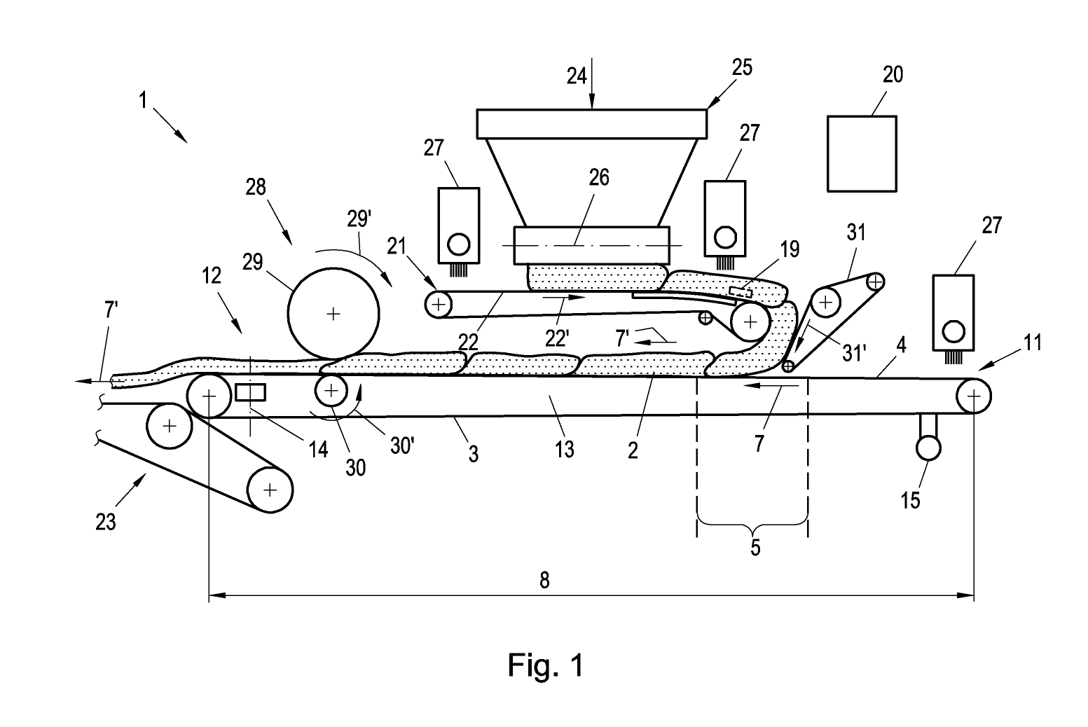

FIG. 1 shows a schematic side view of a device according to the invention.

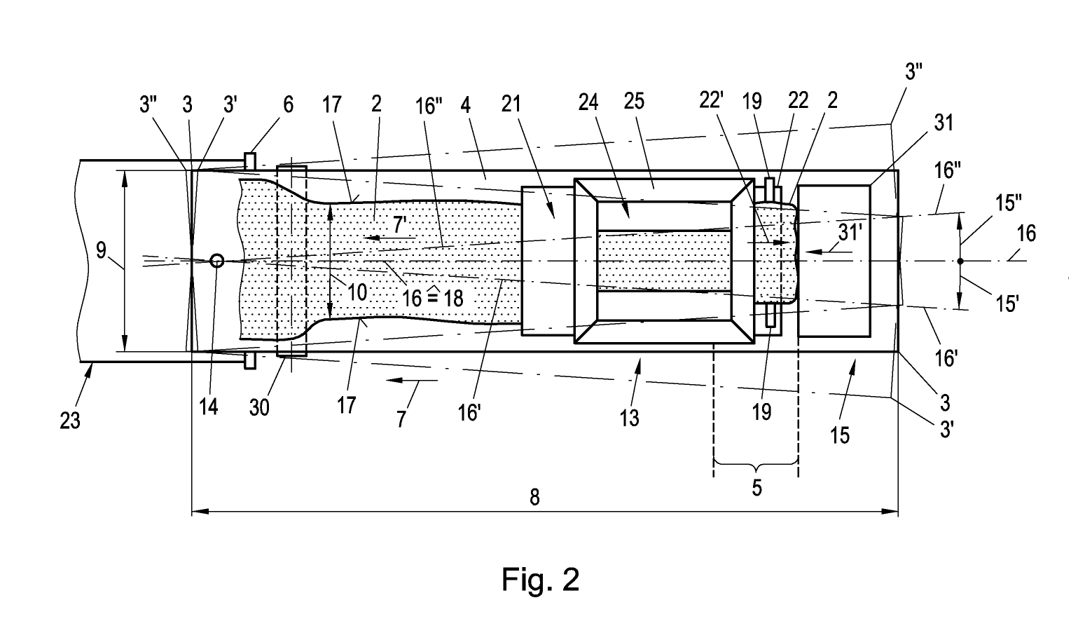

FIG. 2 shows a schematic top view of a device according to the invention.

FIG. 1 shows in a side view an embodiment of a device 1 according to the invention for continuously transporting a dough strand 2. The device 1 comprises a conveyor element 3, onto the support surface 4 of which the dough strand 2 is placed in a transfer section 5. The conveyor element 3, which is herein configured as a continuous conveyor belt, is provided with a drive 6 driving the conveyor element 3 so that the support surface 4 thereof is moved in the direction of transport 7 with the same rate as the dough strand 2 on the preceding transfer device 21 or the subsequent discharge device 22, respectively.

The conveyor element 3 is configured as a conveyor belt and has a length 8 and a width 9, with the width 9 being bigger than the width 10 of the dough strand 2. The frame 13 of the conveyor element 3 extends from the upstream end 11 to the downstream end 12 thereof, viewed in the direction of transport 7. At the frame 13, there is also attached the drive 6 of the conveyor element 3.

The frame 13 is pivotable about a swivelling axis 14, with the swivelling axis 14 being oriented orthogonal to the support surface 4. The swivelling axis 14 is arranged in an end area 12 situated downstream. As depicted in FIG. 2, the swivelling axis 14 is provided centrally of the width 9 of the conveyor element 3 and is positioned in a plane together with the central axis 16 alongside the conveyor element 3. The frame 13 is coupled in regard to its movement at the upstream end 11 of the conveyor element 3 with a swivel drive 15. The end section 11 of the conveyor element 13 is pivotable transversally to its longitudinal direction in the direction of transport 7.

In order to detect the course of the dough strand 2 or the edges 17 thereof, respectively, there are provided width sensors 19 at both sides of the conveyor belt 22 of the transfer device 21. The width sensors are connected with a control unit 20. The control lines between the width sensors 19 and the control unit 20 are not depicted for a better understanding thereof.

Deviations of the central position 18 of the dough strand 2 from the central position 16 of the conveyor element 3 are detected by the control unit 20 through evaluation of the signals of the sensors 19, and the swivel drive 15 is thus controlled correspondingly. By deflecting or swivelling, respectively, the conveyor element 3 at the upstream end 11 from its central position 16, the band course of the dough strand 2 is carefully adjusted across the entire length 8 of the conveyor element 3 or across the support length of the dough strand 2 on the conveyor element 3, respectively, this is the area extending from the transfer section 5 to the downstream end 12.

In order to obtain a transfer of the dough strand 2 from the device 1 to the subsequent discharge device 23 in such a way so that the central position 18 of the dough strand 2 is congruent with the central position 16, this is the symmetry axis in the longitudinal direction, of the conveyor element 3, the transfer of the dough strand 2 has to be carried out at the upstream end 11 of the conveyor element 3 centrally of its width 9 or symmetrically in regard to the central position 16, respectively.

Sensors 19 for detecting the position of both edges 17 of the dough strand are provided at the transfer device 21 arranged upstream of the device 1. The transfer device 21 comprising a conveyor belt 22 may, as is shown in the two FIGS. 1 and 2, be arranged above the conveyor element 3 for reasons of space. The direction of transport 22′ of the conveyor belt 22 herein is opposed to the direction of transport 7 of the conveyor element 22.

Alternatively, there may also be arranged a transfer device 21 upstream of the conveyor element 3. In this case, the direction of transport 22′ of the conveyor belt 22 is oriented in the same direction of transport 7 as the conveyor element 3. This arrangement is not depicted.

For the delivery of the dough 24 there is provided a dough pre-portioner 25, which feeds the necessary dough mass into the dough strand former 26.

There are provided several flour sprinklers 27 in FIG. 1, by means of which the conveyor belts 3 and 22 as well as one or both sides of the dough strand 2 may be sprinkled with flour.

At the downstream end section 12 of the conveyor element 3 there is arranged a dough roller 28, comprising an upper roller 29 as well as a lower roller 30. The directions of rotation 29′ of the upper roller 29 as well as 30′ of the lower roller 30 are in opposition to each other.

Further there is depicted in FIG. 1 a deflection conveyor belt 31, which is moved in the direction of transport 31′. The deflection conveyor belt 31 has the task of supporting the deflection of the dough strand 2 from the conveyor belt 22 of the transfer device 21 to the conveyor element 3 situated underneath. The deflection conveyor belt 31 guarantees that each dough strand 2 is placed within the transfer section 5 onto the support surface 4 of the conveyor element 3.

FIG. 2 shows in a schematic top view the conveyor element 3 according to the invention in operation.

For the delivery of the dough 24, the dough mass to be processed is fed, for example as a dough block, from above into the dough pre-portioner 25. From the dough pre-portioner 25, the dough mass is moved into the subsequent dough strand former 26 and from there onto the conveyor belt 22 of the transfer device 21. Width sensors 19 detect the position of the edges 17 of the dough strand 2, which would, for example, be placed outside of the central position 16 of the conveyor element 3 onto the support surface 4. Then the control unit 20 controls the swivel drive 15 by means of the signals of the sensors 19 in such a way so that the conveyor element 3 is moved about its swivelling axis 14, for example in the swivelling direction 15′ transversal to the direction of transport 7, until it reaches a deflected position 3′. The central position 16′ of the deflected conveyor element 3′, hence, is depicted transversal to the initial central position 16. The dough strand 2 thus coincides with the deflected conveyor element 3 situated underneath in the transfer section 5 in such a way that the dough strand 2 will then rest again centrally of the width 9 of the conveyor element 3. Thereby, the dough strand 2 is then also transferred centrally aligned to the subsequent discharge device 23. An undesired lateral offset of the dough strand 2, for example due to a transversal delivery of the dough strand 2 onto the conveyor belt 22 by the dough strand former 26, may be corrected by the pivotable conveyor element 3.

Analogously, the conveyor element 3 may be moved by means of the swivel drive 15, if required, also in the swivelling direction 15″, until, for example, a deflected position 3″ is reached. The central position 16″ of the deflected conveyor element 3″ thus is arranged transversal to the initial central position 16. The dough strand 2 thus coincides with the deflected conveyor element 3″ situated underneath in the transfer section 5 in such a way that the dough strand 2 will then rest again centrally of the width 9 of the conveyor element 3. Thereby, the dough strand 2 is then also transferred centrally aligned to the subsequent discharge device 23.

By moving the conveyor element 3 back and forth in the swivelling direction 15′ or 15″, respectively, there is obtained that a lateral offset of the dough strand 2 from the central position thereof is adjusted and that the dough strand 2 is always transferred centrally aligned of the width 9 of the conveyor element 3 to the subsequent devices. At the downstream end 12 of the conveyor element 3, hence, the central position 18 of the dough strand 2 coincides with the central position 16 of the conveyor element 3.

List of the Positional Numbers:

1 Device

2 Dough strand

3 Conveyor Element

3′, 3″ Deflected Positions of the Conveyor Element 3

4 Support Surface of the Conveyor Element 3

5 Section of the Support Surface 4, Transfer Section

6 Drive of the Conveyor Element 3

7 Direction of Transport of the Conveyor Element 3

7′ Direction of Transport of the Dough Strand 2

8 Length of the Conveyor Element 3

9 Width of the Conveyor Element 3

10 Width of the Dough Strand 2

11 Upstream End (end section) of the Conveyor Element 3

12 Downstream End (end section) of the Conveyor Element 3

13 Frame of the Conveyor Element 3

14 Swivelling Axis of the Frame 13

15 Swivel Drive

15′, 15″ Swivelling Direction

16 Central Position (in the longitudinal direction) of the Conveyor Element 3

16′, 16″ Central Positions of the Pivoted Conveyer Element 3′ or 3″, respectively

17 Edge of the Dough Strand 2

18 Central Position (in the longitudinal direction) of the Dough Strand 2

19 Width Sensor; Detects Edge 17

20 Control Unit

21 Transfer Device (the device preceding 1)

22 Conveyor Belt of the Transfer Device 21

22′ Feed Direction of the Conveyor Belt 22

23 Discharge Device

24 Dough Delivery

25 Dough Pre-portioner

26 Dough Strand Former

27 Flour Sprinkler

28 Dough Roller

29 Upper Roller

29′ Direction of Rotation of the Upper Roller

30 Lower Roller

30′ Direction of Rotation of the Lower Roller

31 Deflection Conveyor Belt

31′ Direction of Rotation of the Deflection Conveyor Belt 31

1-13. (canceled)

14. A device for continuously transporting a dough strand, comprising:
a conveyor element having a support surface for a dough strand, wherein the support surface is displaceable in a direction of transport of the dough strand, and wherein the conveyor element is pivotable substantially transversally to the direction of transport about a swivelling axis disposed on a downstream end region of the conveyor element.

15. The device according to claim 14, wherein the swivelling axis is arranged centrally of a width of the conveyor element.

16. The device according to claim 14, wherein the swivelling axis is orthogonal to the support surface of the conveyor element.

17. The device according to claim 14, wherein the conveyor element is a conveyor belt.

18. The device according to claim 14, further comprising a swivel drive for swivelling the conveyor element.

19. The device according to claim 18, wherein the swivel drive is arranged at an upstream end of the conveyor element.

20. The device according to claim 18, wherein the upstream end of the conveyor element is pivotable from a central position to both sides by up to 25% of a width of the dough strand transversal to the direction of transport.

21. The device according to claim 18, wherein the upstream end of the conveyor element is pivotable from a central position to both sides by up to 10%, of a width of the dough strand transversal to the direction of transport..

22. The device according to claim 14, further comprising a transfer device configured for transferring the dough strand in a transfer section to the support surface of the conveyor element.

23. The device according to claim 22, wherein the transfer device is a conveyor belt.

24. The device according to claim 22, wherein the transfer device is provided upstream of the conveyor element, and wherein the conveyer belt feeds in a direction of transport of the conveyor element.

25. The device according to claim 22, wherein the transfer device is situated above the conveyor element, and wherein the conveyor belt feeds in opposition to a direction of transport of the conveyor element.

26. The device according to claim 18, further comprising a control unit and sensors for detecting a position of both edges of the dough strand, wherein the control unit controls the swivel drive by signals of the sensors in a way so that the dough strand is positioned in a transfer section of the conveyor element centrally in a width of the conveyor element.

27. The device according to claim 26, wherein the sensors are arranged at the transfer device.

28. The device according to claim 26, wherein the sensors are photoelectric sensors.

29. The device according to claim 26, wherein the sensors are ultrasound sensors.
